(19) United States
(12) Patent Application Publication
(10) Pub. No.: US 2025/0284245 A1
(43) Pub. Date: Sep. 11, 2025

(54) ELECTRONIC TIMEPIECE, EXTERIOR, AND BAND

(71) Applicant: CASIO COMPUTER CO., LTD., Tokyo (JP)

(72) Inventors: Takayuki SATOU, Tokyo (JP); Ayaka HATAKEYAMA, Tokyo (JP)

(21) Appl. No.: 19/070,070

(22) Filed: Mar. 4, 2025

(30) Foreign Application Priority Data
Mar. 5, 2024 (JP) 2024-032603

(51) Int. Cl. G04B 37/00; A44C 5/14

(52) U.S. Cl. CPC G04B 37/005; A44C 5/147

(57) ABSTRACT

Provided is an electronic timepiece including a main body and an exterior that is attached to the main body and can hold a band. The exterior has a first opening on one end. The first opening has a first protruding part protruding inside the first opening on a side facing a back side of the band inserted through the first opening. The band has a first planar part on the back side and a second planar part that swells more than the first planar part on the back side. A boundary between the first planar part and the second planar part forms a step part. When the band is inserted through the first opening of the exterior, the step part and the first protruding part are engaged with each other, thereby holding the band to the exterior.

### REFERENCE TO RELATED APPLICATIONS

This application is based upon and claims the benefit of priority from the prior Japanese Patent Application No. 2024-032603, filed on Mar. 5, 2024, the entire contents of which are incorporated herein by reference.

### TECHNICAL FIELD

The present invention relates to an electronic timepiece, an exterior, and a band.

### BACKGROUND ART

Conventionally, a structure in which a band can be attached to and detached from a timepiece main body has been known. For example, Registered Utility Model No. 3240182 discloses a structure in which a band is fixed as a raised portion with a slit hole is provided on the back face of a timepiece main body and the band is sandwiched between the timepiece main body and a cover by fitting the cover to the raised portion after the band is inserted to the slit hole.

However, in the structure disclosed in Registered Utility Model No. 3240182, it is necessary to detach the cover to detach or attach the band, making it hard to easily detach and attach the band.

### SUMMARY OF INVENTION

According to an aspect of the present disclosure, provided is an electronic timepiece including:
a main body; and
an exterior that is attached to the main body and can hold a band,
wherein the exterior has a first opening on one end,
wherein the first opening has a first protruding part protruding inside the first opening on a side facing a back side of the band inserted through the first opening,
wherein the band has a first planar part on the back side and a second planar part that swells more than the first planar part on the back side,
wherein a boundary between the first planar part and the second planar part forms a step part,
wherein when the band is inserted through the first opening of the exterior, the step part and the first protruding part are engaged with each other, thereby holding the band to the exterior.

### BRIEF DESCRIPTION OF DRAWINGS

FIG. 1 is a perspective view of a major part showing how an exterior member according to an embodiment is attached to the frontal face side of a timepiece main body according to the embodiment.

FIG. 2 is a plan view of the back face side of the timepiece main body according to the embodiment.

FIG. 3 is a perspective view of the exterior member according to the embodiment as viewed from the inside.

FIG. 4 is a plan view of the timepiece main body with the exterior member attached thereto as viewed from the back face side.

FIG. 5 is a lateral view of the timepiece main body with the exterior member attached as viewed from a direction of an arrow V in FIG. 4.

FIG. 6A is a perspective view of a band according to the embodiment as viewed from a back side.

FIG. 6B is a perspective view of a major part showing how the band shown in FIG. 6A is attached to the timepiece main body with the exterior member attached.

FIG. 7A is a frontal view of a timepiece according to a first embodiment.

FIG. 7B is a rear view of the timepiece shown in FIG. 7A.

FIG. 7C is a cross-sectional view taken along a line c-c of the timepiece shown in FIG. 7A.

FIG. 8 is a cross-sectional view taken along a line VIII-VIII of the timepiece main body with the exterior member attached in FIG. 4.

FIG. 9 is a cross-sectional view taken along a line IX-IX of the timepiece main body with the exterior member attached in FIG. 4.

FIG. 10 is a cross-sectional view taken along a line X-X of the timepiece shown in FIG. 7A.

FIG. 11 is a cross-sectional side view of the major part showing how the band is attached to the exterior member attached to the timepiece main body.

FIG. 12 is a cross-sectional side view of the major part showing a state in which the band is attached to the exterior member attached to the timepiece main body.

FIG. 13 is a cross-sectional side view of the major part showing an illustration of how the band of the timepiece in FIG. 12 is put around a wrist of a wearer.

FIG. 14 is a frontal view of a timepiece according to a second embodiment.

FIG. 15 is a perspective view showing how the timepiece according to the second embodiment is assembled by attaching an exterior case to the timepiece main body.

FIG. 16 is a plan view of the back face side of the timepiece shown in FIG. 14.

FIG. 17 is a plan view showing a state in which a back cover is detached from the timepiece shown in FIG. 16.

FIG. 18 is a cross-sectional view taken along a line XVIII-XVIII of the timepiece shown in FIG. 16.

### DETAILED DESCRIPTION

Embodiments of an electronic timepiece according to the present disclosure are described with reference to the drawings. Various limitations technically preferable for carrying out the present disclosure are provided in the following embodiments. However, the scope of the present invention is not limited to the embodiments below or illustrated examples. In the embodiments hereinbelow, the electronic timepiece is simply referred to as a “timepiece.”

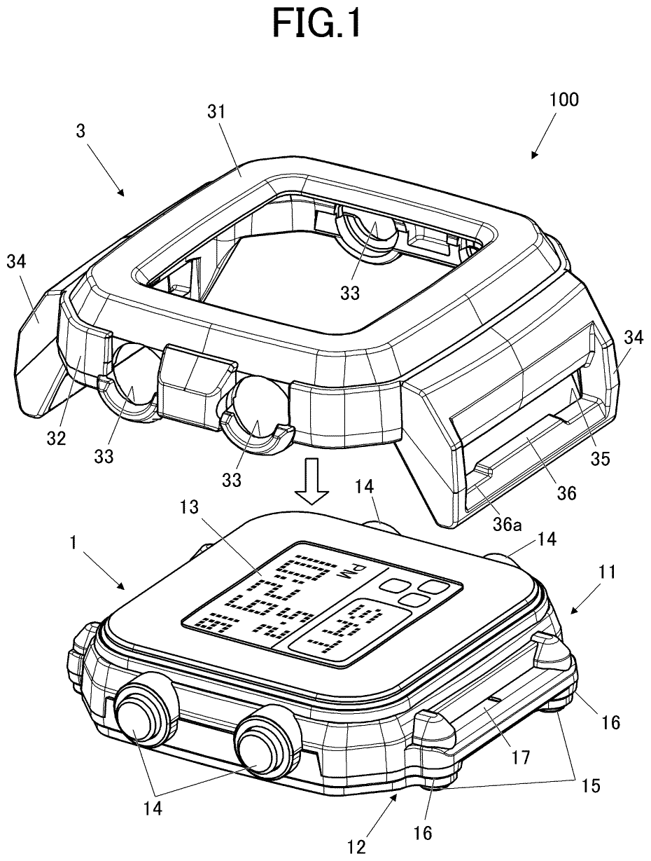

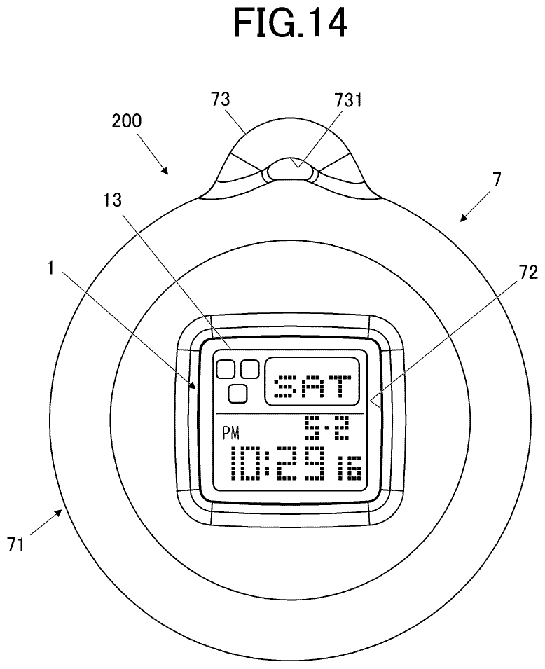

As shown in FIGS. 1, 14, etc., the timepiece according to the present embodiment includes an electronic timepiece main body (hereinafter simply referred to as a “timepiece main body 1”) (a main body), an exterior member (an exterior) attachable to the timepiece main body 1. In the embodiment, the exterior member is a first member or a second member selectively attached to the timepiece main body 1. The first member is a bezel 3 to which a band 5 can be attached, and the second member is an exterior case 7. The bezel 3 and the exterior case 7 can be attachable to and detachable from the timepiece main body 1. In the following description, a “timepiece 100” in the first embodiment is in a state where the bezel 3 is attached to the timepiece main body 1, and a “timepiece 200” in the second embodiment is in a state where the exterior case 7 is attached to the timepiece main body 1. The configuration of the timepiece main body 1 is common in the first and second embodiments. Thus, the timepiece main body 1 is described as a configuration common in the first and second embodiments.

The timepiece main body 1 according to the embodiment includes a main body case 11 which houses a timepiece module (not shown in the drawings) inside and a back cover 12 attached to the back side of the main body case 11. The main body case 11 is formed of a kind of synthetic resin, for example, and the back cover 12 is formed of a kind of metal such as a stainless steel (SUS), for example.

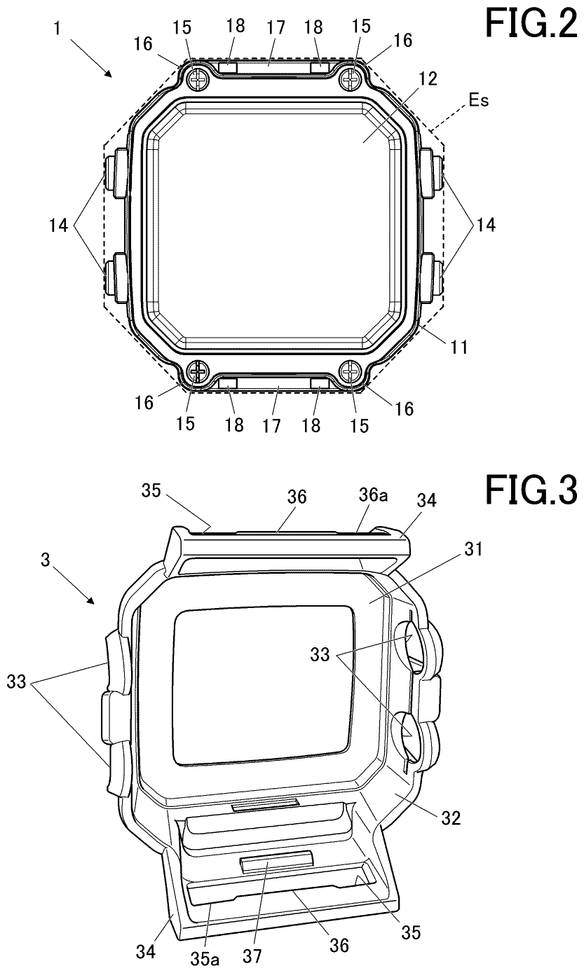

The timepiece main body 1 in the embodiment is formed to have an external shape of a substantially rectangle in a plan view, as shown in FIG. 2. The timepiece main body 1 has outwardly extending protrusions on the outer side. The apexes of the protrusions on the extending side form an outermost shape Es of the timepiece main body 1. In FIG. 2, the outermost shape Es of the timepiece main body 1 is shown by a dashed line. As shown in FIG. 2, the timepiece main body 1 according the embodiment is approximately symmetrical vertically and laterally, and the forms and the lengths of the sides facing each other (corresponding to the 6 and 12 o'clock sides and the 3 and 9 o'clock sides) are almost the same. (Hereinafter, when referred to a “o'clock” side, it indicates each side of the timepiece as on a dial of an analog watch.) The timepiece main body 1 is in the same shape when rotated 180 degrees.

The timepiece module housed in the main body case 11 includes components necessary for the watch functions such as a display unit that displays information such as time, a driver that drives the display, and a circuit that controls these (none of which are shown in the drawings), for example. In the present embodiment, the display includes a display panel 13 (see FIG. 1) exposed to the front face side of the timepiece main body 1 and displays various pieces of information such as time, date, and day on the display panel 13. The display panel 13 is constituted of, for example, a liquid crystal display (LCD), an organic electroluminescence display, or another flat display. The display unit is not limited to the one with the display panel 13 displaying the date and the like. It may be a display unit of an analog type with hands and a dial or a so-called combination model with a display unit capable of analog and digital display.

Operation units 14 are provided on the lateral sides of the main body case 11. The operation units 14 are parts through which the user inputs various operations, which are a push button, a crown, and the like, for example. In FIGS. 1 and 2, two of the operation units 14 are provided on the 3 o'clock side and other two are provided on the 9 o'clock side, for example. The operation units 14 are second protruding parts on the timepiece main body 1. The operation units 14 extend outward on the 3 and 9 o'clock sides of the timepiece main body 11, and as shown by a broken line in FIG. 2, the apexes of the protrusions on the extending side form the outermost shape Es on the 3 and 9 o'clock sides of the timepiece main body 1.

As shown in FIG. 2, the back cover 12 is attached to the main body case 11 by being screwed on the opposing two sides of the timepiece main body 1. Screw hole spaces 16 are provided at the portions where the main body case 11 and the back cover 12 are screwed together. In the embodiment, the back cover 12 is screwed with two screws 15 each on the 6 and 12 o'clock sides. That is, the portions where the back cover 12 is screwed (the screw hole spaces 16) are on the sides different from those on which the operation units 14 are provided.

The back cover 12 is screwed not to interfere with the timepiece module housed in the main body case 11. Thus, the screw hole spaces 16 are protrusions provided outside the space where the timepiece module is housed and formed on the outer periphery of the timepiece main body 1. The screw hole spaces 16 as the protrusions extend outward from the timepiece main body 1, and as shown by a broken line in FIG. 2, the apexes of the protrusions on the extending side form the outermost shape Es on the 6 and 12 o'clock sides of the timepiece main body 1.

First protruding parts 17 are formed between adjacent ones of the screw hole spaces 16 as the protrusions by adding a material to bridge the gap between the adjacent screw hole spaces 16. The first protruding parts 17 are provided in a range that does not go over the line connecting the apexes on the protruding side of the corresponding screw hole spaces 16 (i.e., inside the outermost shape Es of the timepiece main body 1). In the embodiment, the first protruding part 17 is formed to connect the adjacent ones of the screw hole spaces 16 (protrusions) so that the first protruding part 17 and the screw hole spaces 16 are aligned substantially flush as shown in FIG. 2, for example. Thus, the outermost shape Es of the timepiece main body 1 can be a shape of an excellent design with less unevenness. The shape of the first protruding parts 17 is not limited to the illustrated examples, and may be recessed inward from the line connecting the adjacent ones of the screw hole spaces 16 (protrusions). In the embodiment, at least the central part of the first protruding part 17 in the width direction functions as an engaging part on the timepiece main body 1 side at which a member-side locking part (a first engaging part 37 or a second engaging part 77) is stopped when the bezel 3 (the first member) or the exterior case 7 (the second member 7) as an exterior member described later is attached.

For the timepiece 100 according to the embodiment, the band 5 is positioned to go through the back face side of the timepiece main body 1 (the side on which the back cover 12 is provided) when the band 5 is attached thereto. The screws 15 that fix the back cover 12 are positioned on a path where the band 5 passes when the band 5 is being attached. The screws 15 are provided on the back face side of the timepiece main body 1 and formed of a metal such as stainless steel (SUS) or the like. Thus, in a case where the band 5 is in contact with the screws 15 (especially screw head) the front surface of the band 5 may be rubbed or scraped and damaged.

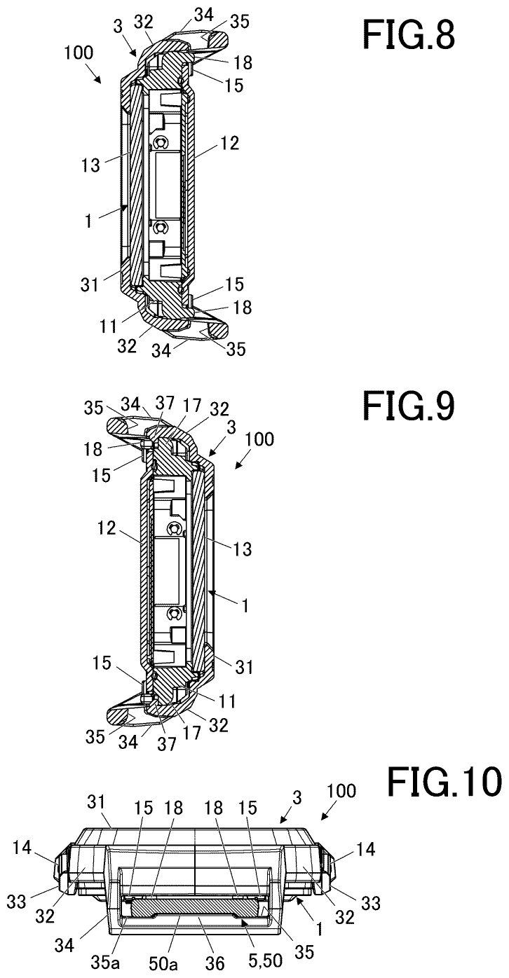

In this regard, protective protrusions 18 which protrude from the line connecting the apexes (screw heads) of the screws 15 are provided in the vicinity of the screws 15, on the back side of the first protruding part 17 (the back face side of the timepiece main body 1) on the timepiece main body 1 according to the embodiment (see FIGS. 2, 4, and 10). How much the protective protrusions 18 protrude from the line connecting the apexes of the screws 15 (screw heads) is determined as appropriate. If the protective protrusions 18 protrude too much, the protective protrusions 18 obstruct the passage of the band 5 when the band 5 is being attached. Thus, as shown in FIG. 8, for example, it is preferable that the protective protrusions 18 go over the line connecting the apexes of the screws 15, but do not go below the surface on the back side of the back cover 12.

The protective protrusions 18 are illustrated as a quadrangular prism having a substantially rectangular shape in plan view in FIG. 2, etc., but the shape or the like of the protective protrusions 18 is not limited to the illustrated example. For example, the protective protrusions 18 may be in a cylindrical shape with a circular or elliptical shape in plan view, or the like. The protective protrusions 18 have chamfered or round edges at corners on the surface on the side opposing the band 5 so that the surface of the band 5 is not easily caught.

Foe example, conventionally, there has been proposed a structure in which a band is fixed as a raised portion with a slit hole is provided on the back face of a timepiece main body and the band is sandwiched between the timepiece main body and a cover by fitting the cover to the raised portion after the band is inserted to the slit hole. However, in such a structure, it is necessary to detach the cover to detach or attach the band, making it hard to easily detach and attach the band. In this regard, the structure according to the present embodiment, the band 5 can be easily attached to and detached from the timepiece main body 1. Furthermore, it is possible to use the timepiece main body 1 housed in the exterior case 7 without the band 5 (second embodiment).

### First Embodiment

The exterior member (the first member) constituting the timepiece main body 100 according to the first embodiment is the bezel 3 attached to the timepiece main body 1. The bezel 3 has a first opening formed at one end at least. The band 5 is inserted through the first opening, and a first protruding part 36 that protrudes inside the first opening is provided on an edge 35a that faces the back side of the band 5 (the surface not visible when the band is worn on the arm, the lower side in FIG. 10) when the band 5 is inserted through the first opening. In the present embodiment, the bezel 3 is attached to the timepiece main body 1 so as to surround the outer periphery of the timepiece main body 1. The bezel 3 according to the present embodiment is described in detail below with reference to FIGS. 1, 3, etc.

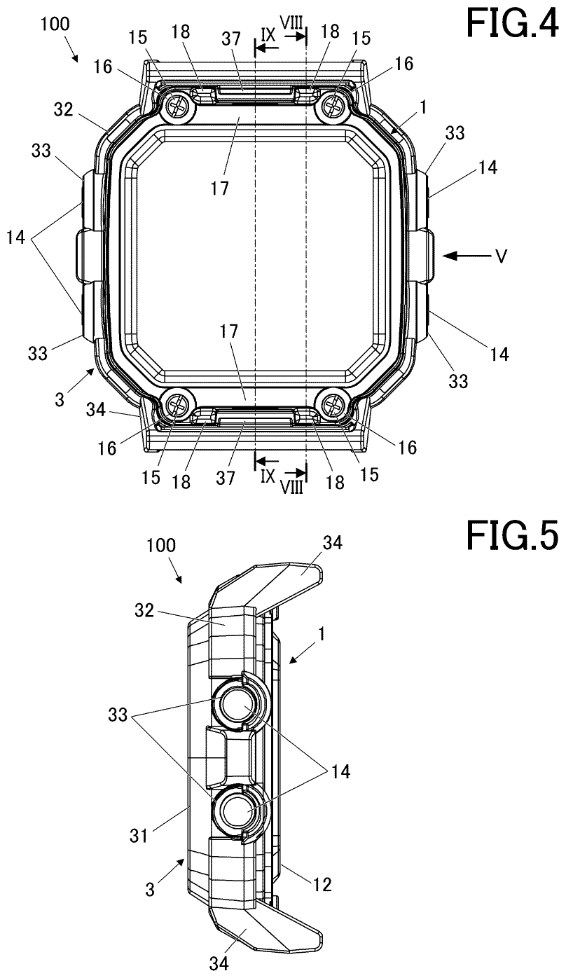

As shown in FIGS. 1 and 3, the bezel 3 according to the present embodiment includes a frame-shaped part 31, a lateral part 32, and an extending part 34 (a first extending part, a second extending part). The frame-shaped part 31 is disposed on the front face side of the timepiece main body 1 when the timepiece main body 1 is worn. The lateral part 32 goes downward from the frame-shaped part 31 and is provided on the lateral part of the timepiece main body 1 when the timepiece main body 1 is worn. The extending parts 34 extend downward from the back face (the back cover 12 in the present embodiment) of the timepiece main body 1 when the bezel 3 is attached to the timepiece main body 1. In the present embodiment, as shown in FIGS. 4, 5, etc., a pair of extending parts 34 is provided so as to face each other with the timepiece main body 1 in between when the bezel 3 is attached to the timepiece main body 1.

In the embodiment, as shown in FIG. 1, the bezel 3 is attached to the timepiece main body 1 from the front face side, and the extending part 34 is provided on the side of the timepiece main bod y1 on which the first protruding part 17 is provided. That is, in the embodiment, the extending part 34 is provided each on the 6 and 12 o'clock sides when the bezel 3 is attached to the timepiece main body 1. The bezel 3 is formed of a urethane resin such as polyurethane (PUR), for example. The bezel 3 is preferably formed of a synthetic resin such as urethane resin and has flexibility overall. At least the extending part 34 can be elastically deformed. But the material forming the bezel 3 is not limited to this.

When the bezel 3 is attached to the timepiece main body 1, at least part of the display panel 13 of the timepiece main body 1 is exposed in the frame-shaped part 31 so that various information such as the time is visible on the display. In the lateral part 32, engagement holes 33 are formed respectively at positions corresponding to the operation units 14 of the timepiece main body 1 when the bezel 3 is attached to the timepiece main body 1. In the embodiment, the engagement holes 33 are through holes which the operation units 14, as a second protruding part, are inserted through, and when the bezel 3 is attached to the timepiece main body 1, the operation units 14 are fitted into the engagement holes 33. In the state where the bezel 3 is attached to the timepiece main body 1, the operation units 14 are exposed from the engagement holes 33 and the operation units 14 can be externally operated while the bezel 3 is attached.

The pair of the extending parts 34 respectively has a pair of openings 35. One of the openings 35 provided on one of the extending parts is referred to as the first opening and the other one of the openings 35 provided on the other one of the extending parts 34 is referred to as a second opening. The band 5 is inserted through the openings 35 when the band 5 is worn, and has a width equal to or greater than the width of the band 5. The openings 35 only need to face each other with the timepiece main body 1 in between when the bezel 3 is attached to the timepiece main body 1, and in a case where the lateral part 32 extends downward from the back face of the timepiece main body 1, for example, the openings may be formed at the positions where the lateral parts 32 face each other.

The protruding part 36 (the first protruding part) that protrudes inside the opening 35 (the first opening) is provided on the edge 35a of the opening 35 which faces the surface of the back side of the band 5 when the band 5 is inserted to the opening 35. The first protruding part is provided on the first opening on one end of the bezel 3, but in the present embodiment, the first opening and the second opening are provided at positions facing each other with the timepiece main bod y1 in between, and these openings 35 respectively have the protruding parts 36 (the first protruding part and the second protruding part) that protrude inside the openings 35 (the first opening and the second opening). The protruding part 36 may be provided only on one of the pair of the openings 35 (the first opening and the second opening).

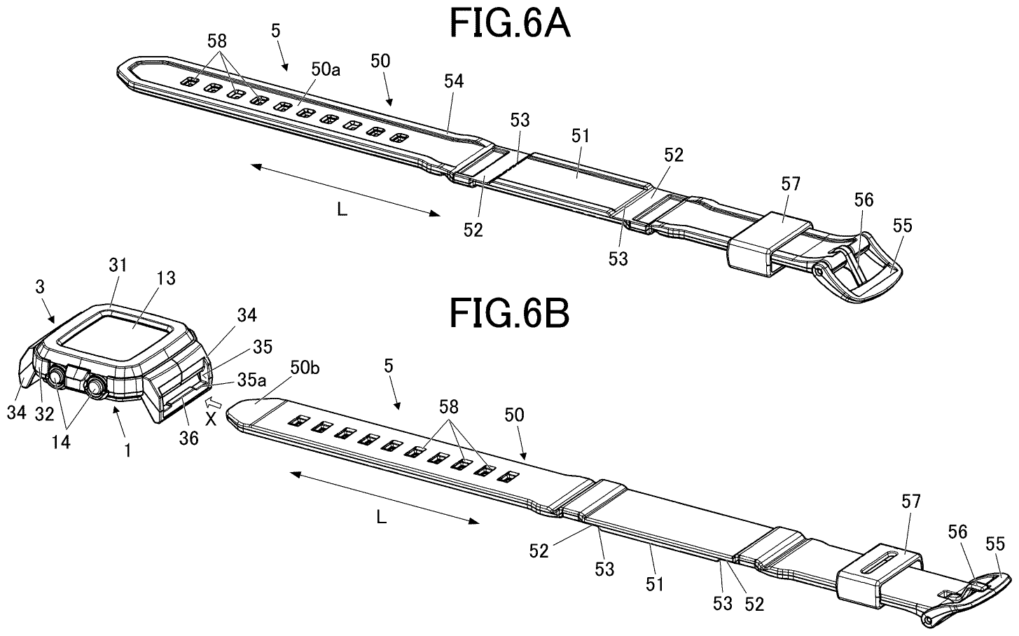

The band 5 inserted through the opening 35 includes a second part 52 which is a first planar part on the back side as described later and a first part 51 which: is a second planar part protruding from the level of the second part 52 (the first planar part on the back side). That is, the first part 51 as the second planar part and the second part 52 as the first planar part have different heights in the thickness direction, and the first part 51 swells toward the back side more than the second part 52 and is higher in the thickness direction. As described later, the boundary part between the first part 51 as the second planar part and the second part 52 as the first planar part forms a step part 53. In the embodiment, the first part 51 is just thick enough to allow itself to pass through the part of the bezel 3 where the protruding part 36 is provided or thicker than that (first thickness). However, the protruding part 36 can be elastically deformed, and when the first part 51 gets caught when the band 5 is inserted to the opening 35, the protruding part 36 can be bent along the insertion direction X (see FIG. 6), allowing the first band 5 to pass. The protruding part 36 gets back to the original state when it is disposed at the second part 52, and is fitted to the step part 53 which is the boundary part between the first part 51 and the second part 52. The tip of the protruding part 36 preferably has a chamfered or round edge on the upstream side in the insertion direction X of the band 5 so that the band 5 can be easily inserted. The protruding part 36 is preferably angled (inclined) slightly toward the insertion direction X of the band 5.

The bezel 3 is also provided with a member-side locking part stopped by the first protruding part 17 at a position corresponding to the first protruding part 17 when the bezel 3 is attached to the timepiece main body 1. In the present embodiment, the member-side locking part is a first engaging part(s) 37. The first engaging parts 37 are provided on the inner sides of the pair of the extending parts 34 and above the openings 35, as shown in FIG. 3. As shown in FIG. 9, etc., the first engaging part 37 is a hook-shaped or hook-like claw or protrusion that protrudes toward the inside of the bezel 3, and is positioned so as to be in contact with the first protruding part 17 from below (the underside, the back side in FIG. 1) when the bezel 3 is attached to the timepiece main body 1 so as to surround the outer periphery of the timepiece main body 1.

As described above, in the present embodiment, the bezel 3 as the first ember has: the first engaging parts 37 as the member-side locking part provided at the positions corresponding to the first protruding parts 17; and the engagement holes 33 provided at the positions corresponding to the operation units 14. In the state where the bezel 3 is attached to the timepiece main body 1, as the first engaging parts 37 engage with the first protruding parts 17 and the operation units 14 are fitted to the engagement holes 33, the bezel 3 is locked to the timepiece main body 1.

Furthermore, in the first embodiment, as the band 5 is connected to the bezel 3 attached to the timepiece main body 1, the timepiece 100 functions as a wristwatch that can be worn on the wrist Wr (the wrist Wr is shown by a dotted line in FIG. 13) as the target wearer. As shown in FIG. 6A, the band 5 includes a band main body 50, and a buckle 55 and a pin 56 on one end of the band main body 50. A free loop 57 through which the other side of the band 5 is inserted when the band 5 is worn on the target wearer (the wrist Wr) is provided on the side of the band main body 50 on which the buckle 55 etc. are provided.

The band main body 50 is formed of any of a variety of relatively flexible synthetic resins including urethane resins such as polyurethane (PUR), silicone resins, and fluorine-containing rubber, for example, and is formed in the shape of a long strip with flexibility. The band main body 50 has a sweat escape shape part 50a (sweat escape part) at a central part in the width direction recessed than the surrounding other part, and the band 5 is prevented from sticking to the skin when the band 5 is worn on the wrist Wr, etc.

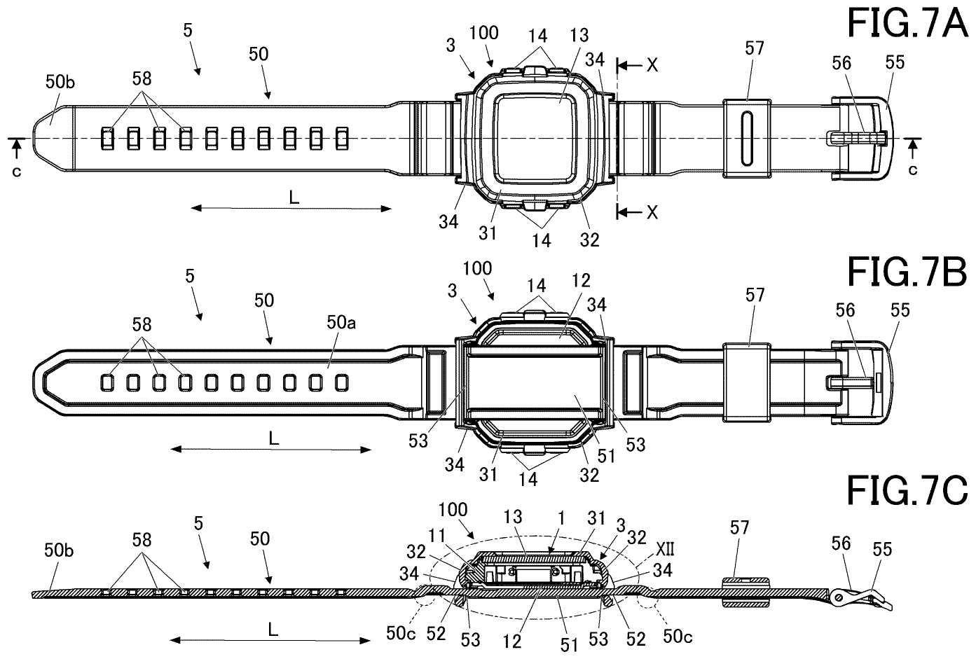

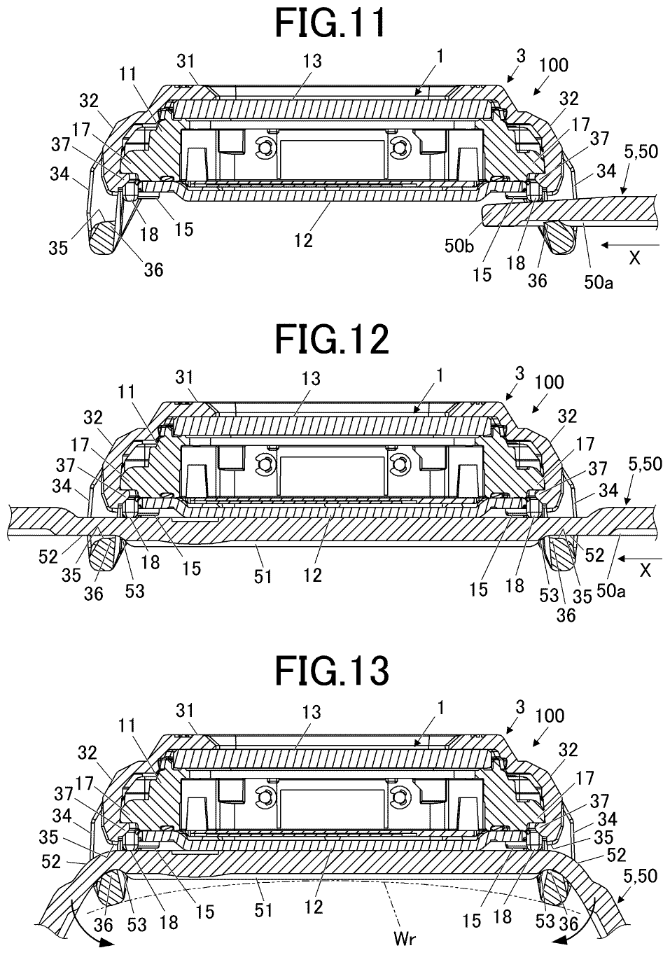

As shown in FIGS. 6A, 6B, etc., the band main body 50 includes the first part 51 with the first thickness approximately in the center in the longitudinal direction L and the second parts 52 thinner than the first part 51 on the both sides of the first part 51 in the longitudinal direction L. The boundary part between the first part 51 and the second part 52 is the step part 53. In the state where the bezel 3 is attached to the timepiece main body 1, the band 5 is inserted through the pair of the openings 35 of the bezel 3 at the positions facing each other with the timepiece main body 1 in between from the side of an insertion-side end 50b of the band main body 50 (see FIGS. 6B and 11), and as shown in FIGS. 7A to 7C, the band 5 is disposed so as to go on the back side of the timepiece main body 1.

The band main body 50 has an uneven part 50c where there is a step(s) on the back (for example, see the part surrounded by a dashed line in FIG. 7C) for improving the design and fitting the wrist Wr when the band 5 is worn on the wrist Wr. However, the uneven part 50c like this is angled more slightly than the step part 53 with respect to the reference level (the surface of the band main body 50), which makes it easier to pull the band 5 into the opening 35 and makes it less likely to get the band 5 stuck. Further, the band main body 50 has some parts that are thicker on the front side and some parts that are thicker on the back side, but the thickness of the band main body 50 is generally uniform overall. This makes it easier to pull the band 5 through the opening 35 of the bezel 3 to attach or detach the band 5. As the thickness of the entire band is mostly uniform, it is easier to apply decorative surface printing or the like to the band 5.

In the embodiment, the insertion-side end 50b has a tapered shape, thinner and narrower toward the ends. This makes it possible to more smoothly insert the band 5 (the band main body 50) into the opening 35. In FIGS. 6B, 11, and 12, the direction in which the band 5 is inserted to the opening 35 of the bezel 3 is indicated as an insertion direction X. In the state where the first part 51 is on the back face side of the timepiece main body 1 (as shown in FIG. 12), the protruding part 36 protruding inside the opening 35 of the bezel 3 engages with the step part 53 of the band 5. The band 5 is thereby supported to the bezel 3. As the band 5 is inserted to the back face side of the timepiece main body 1 like that, the timepiece main body 1 is sandwiched between the bezel 3 and the band 5 (as shown in FIGS. 7B, 7C, and 12). Thus, the engagement state of the timepiece main body 1 and the bezel 3 is more steadily supported, making it possible to prevent the timepiece main body 1 from coming off the bezel 3.

Next, the effects of the timepiece 100 as the electronic timepiece according to the first embodiment are described with reference to FIGS. 10 to 13. In the first embodiment, when the bezel 3 as the first member is attached to the timepiece main body 1, the bezel 3 covers the timepiece main body 1 from the front face side as shown in FIG. 1 so that at least part of the display panel 13 is exposed in the framed area of the frame-shaped part 31. Further, while the bezel 3 is being expanded slightly, the operation units 14 provided on the 3 and 9 o'clock sides of the timepiece main body 1 are respectively fitted into the engagement holes 33 of the bezel 3 so that the protruding tips (the button head parts) are exposed from the engagement holes 33 to be operable. The bezel 3 is locked to the timepiece main body 1 as the first engaging parts 37 as the member-side locking part are engaged with the first protruding parts 17 provided on the 6 and 12 o'clock sides.

Once the bezel 3 is locked to the timepiece main body 1, the band main body 50 of the band 5 is inserted to the opening 36 of the bezel 3 from the side of the timepiece 100 on which the buckle 55 and the pin 56 of the band 5 are provided (the 12 o'clock side in the embodiment), as shown in FIG. 6B. As shown in FIG. 11, the extending parts 34 (the protruding part 36 provided on the extending part 34) are elastically deformable, and when the band 5 is inserted to the opening 35, the extending part 34 is appropriately inclined along the insertion direction X to pass the band 5. When the band 5 is pulled through until the first part 51 corresponds to the back face side of the timepiece main body 1 and the protruding part 36 is positioned at the second part 52 thinner than the first part 51, the protruding part 36 is back to the original state and engages with the step part 53 as shown in FIG. 12.

In the present embodiment, as shown in FIG. 10, the protruding part 36 is fitted to the sweat escape shape part 50a recessed relative to the surrounding part in the cross section of the band main body 50 as shown in FIG. 10. Therefore, the sweat escape shape part 50a acts as a guide, making it possible to pull the band main body 50 along the insertion direction X. The band 5 is pulled into the opening 35 with the front side of the band main body 50 facing the back face side of the timepiece main body 1. The protective protrusion 18 in the vicinity of the screws 15 exposed to the back face side of the timepiece main body 1. This prevents the surface of the band main body 50 from interfering with the screw 15 and being damaged.

As shown in FIG. 13, when the timepiece 100 with the band 5 attached is to be worn on the wrist Wr of the user, the band 5 is wound around the wrist Wr, the pin 56 is inserted to a small hole 58 corresponding to one's own wrist size and locked, and the buckle 55 is passed through. The remaining end of the band main body 50 (the end on the side of the insertion-side end 50b) is passed through the free loop 57 and secured therein. Here, the small hole 58 is arranged on one end of the band 5 that is inserted through the opening 35, and the buckle 55 and the pin 56 are provided on the other end that is not inserted through the opening 35. When the band 5 inserted through the opening 35 is worn on the wrist Wr, both ends of the band 5 are pulled in the direction along the wrist Wr (indicated by an arrow in FIG. 13). As a result, the second part 52, which is relatively thin, flexes and deforms to fit the wrist Wr, and the extension part 34 in which the opening 35 is provided elastically deforms to flex inward (the side indicated by the arrow in FIG. 13, in the direction toward the timepiece main body 1), and the protruding part 36 of the opening 35 is pressed against the step part 53 when the extending part 34 is in the flexed state. This allows the timepiece 100 of this embodiment to be worn on a target object such as the wrist Wr, and the band 5 is firmly fixed to the bezel 3, more reliably preventing it from falling off. In this state, the timepiece main body 1 is also sandwiched between the band 5 and the bezel 3 and is securely fixed in place.

When removing the bezel 3 from the timepiece main body 1, first, the band 5 is removed from the opening 35 in the extending part 34 of the bezel 3. When removing the band 5 from the bezel 3, the band 5 is pulled out in the direction opposite to the insertion direction X after it has been removed from the wrist Wr. After the band 5 is removed, the extending parts 34 of the bezel 3 are pushed apart (outwardly in the directions of the 6 o'clock side and the 12 o'clock side). The first engaging part 37 as a member-side locking part provided on each of the extending parts 34 is thereby removed from the underside of the first protruding part 17 of the timepiece body 1, and the engagement state is thereby released. The lateral parts 32 of the bezel 3 are also pushed apart in the directions in which they separate (outward in the direction of the 3 and 9 o'clock sides), and the operation units 14 inserted through the engagement holes 33 are removed. The fitted state is thereby released. This allows the band 5 and bezel 3 to be removed from the timepiece main body 1.

As described above, the bezel 3 of the timepiece 100 of the present embodiment can be easily attached to and detached from the timepiece main body 1, and it is possible to replace it with a different bezel 3 having a different color, material, shape, etc., or to replace the band 5 attached to the bezel 3. Furthermore, it is also possible to attach a member other than the bezel 3 (such as an exterior case 7 shown in the second embodiment) to the timepiece main body 1.

Next, the effects of the timepiece 100, the electronic timepiece according to the first embodiment, the bezel 3, and the band 5 will be described.

The timepiece 100, which is the electronic timepiece according to the present embodiment, includes the timepiece main body 1 and the bezel 3 as the exterior member that is attached to the timepiece main body 1 and can hold the band 5. The bezel 3 has the opening 35 (first opening) on one end, and the opening 35 has the protruding part 36 (first protruding part) protruding inside the opening 35 on the side 35a facing the back side of the band 5 inserted through the opening 35. The band 5 has the second part 52 (first planar part) on the back side and the first part 51 (second planar part) that swells more than the second part 52 on the back side. The boundary between the second part 52 and the first part 51 forms the step part 53. When the band 5 is inserted through the opening 35 of the bezel 3, the step part 53 and the protruding part 36 are engaged with each other, thereby holding the band 5 to the bezel 3 and the timepiece main body 1 with the bezel 3 attached.

As described above, in the present embodiment, as the band 5 is attached to the bezel 3 attached to the timepiece main body 1, the timepiece main body 1 is sandwiched and fixed between the band 5 and the bezel 3, and it is possible to ensure that the timepiece 100 will not easily come off when worn on the wrist Wr. On the other hand, the band 5 is only engaged with the protruding parts 36 of the bezel 3, and can be easily removed by releasing the part hooked on the protruding parts 36 (the step parts 53 in the embodiment). Thus, the user can easily attach and detach the band 5 to and from the timepiece main body 1, and can enjoy changing the band 5 and other parts.

In the embodiment, the bezel 3 (at least the protruding parts 36 of the bezel 3) is elastically deformable, and when the band 5 is inserted to the opening 35, the band 5 is inclined along the insertion direction X to pass through the opening 35 and is back to the original state at the second part 52 where it is thinner. The band 5 is thereby engaged with the step parts 53 which is the boundary with the first part 51. Therefore, the band 5 can be pulled through the opening 35 smoothly with little resistance, and the elastic deformation of the protruding parts 36 can be used to ensure that the band 5 is securely engaged with the step parts 53. This allows the user to easily put on and take off the band 5 without any stress.

Furthermore, as described above, the bezel 3 of the embodiment is detachable from the timepiece main body 1, so that it can be easily replaced with another bezel 3 having a different color, material, shape, etc., or the band 5 attached to the bezel 3 can be replaced. Various exterior cases other than the bezel 3 can be easily attached.

The bezel 3 in the embodiment has the pair of the extending parts 34 that extend downward from the back face of the timepiece main body 1 at opposing positions across the timepiece main body 1 when the bezel 3 of the embodiment is attached to the timepiece main body 1, and the pair of the openings 35 are respectively formed in the pair of the extending parts 34. Thus, even when the timepiece main body 1 is to be used as a wristwatch with a band, it is not necessary to provide a band attachment portion on the timepiece main body 1, and the timepiece main body 1 can be compact. Furthermore, as the band 5 is pulled through the pair of the openings 35, the timepiece main body 1 can be held from the back side. It is thereby possible to more reliably prevent the timepiece main body 1 from coming off the bezel 3.

In the embodiment, when the band 5 inserted through the opening 35 is worn on the wrist Wr, the extending parts 34 are pulled and bent toward the wrist Wr to be elastically deformed. The protruding parts 36 of the openings 35 are pressed against the step parts 53 in the state where the extending parts 34 are bent. This makes it difficult for the band 5 and the timepiece main body 1 to come off the bezel 3 in the state where the band 5 is worn on the wrist Wr because the timepiece main body 1, the bezel 3, and the band 5 are more securely integrated.

The timepiece main body 1 in the embodiment is provided with the first engaging parts 37 at the positions corresponding to the first protruding parts 17 when the bezel 3 is attached thereto. The bezel 3 is locked to the timepiece main body 1 as the first engaging parts 37 are engaged with the first protruding parts 17. The timepiece main body 1 in the embodiment has the operation units 14 as the second protruding parts beside the first protruding parts 17, and the bezel 3 as the first member has the engagement holes 33 at the positions corresponding to the operation units 14. When the bezel 3 is attached to the timepiece main body 1, the bezel 3 is locked to the timepiece main body 1 as the first engaging parts 37 are engaged with the first protruding parts 17 and the operation units 14 are fitted to the engagement holes 33. Thus, the bezel 3 can be locked to the timepiece main body 1 with a stronger fixing force than when the bezel 3 is locked to the timepiece main body 1 with the engagement between the first engaging parts 37 and the first protruding parts 17.

The engagement holes 33 are through holes through which the operation units 14 are inserted, and the operation units 14 are exposed from the engagement holes 33 in the state where the bezel 3 is attached to the timepiece main body 1. Thus, the user can operate the operation units 14 of the timepiece main body 1 while the bezel 3 is attached thereto. And as the operation units 14 are locked inside the through holes, it is possible to gain the fixing force to lock the bezel 3 to the timepiece main body 1 just by fitting the operation units 14 to the engagement holes 33.

Especially, the timepiece main body 1 in the present embodiment is formed in an approximately rectangular shape in plan view, and the first protruding part 17 is provided on each of two opposing sides of the timepiece main body 1 (the lateral faces on the 6 and 12 o′clock sides of the timepiece), and the second protruding parts, which are the operation units 14, are provided on the lateral faces on the 3 and 9 o'clock sides of the timepiece, which are different from the sides on which the first protruding parts 17 are provided. Thus, when the first engaging parts 37 and the first protruding parts 17 are engaged with each other and the operation units 14 are fitted into the engagement holes 33, the timepiece main body 1 can be locked on three or more sides, and the bezel 3 can be more stably locked to the timepiece main body 1.

The back cover 12 is screwed to the back face side of the timepiece main body 1, and the screws 15 that fix the back cover 12 are arranged on the path through which the band 5 passes when the band 5 is inserted to the opening 35 of the bezel 3. The protective protrusions 18 that protrude beyond the screw heads are provided near the screws 15. This can prevent the surface of the band 5 from interfering with the screw 15 and being damaged. In the embodiment, the protruding parts 36 are provided on the sides 35a of the openings 35 facing the back surface of the band 5 and protrude into the openings 35, and are positioned so as to sandwich the band 5 from both the front and back with the protective protrusion 18 provided on the back face side of the timepiece main body 1. Thus, the protective protrusions 18 can prevent the band 5 from shifting and falling off in combination with the engagement between the protruding parts 36 and the step parts 53. The effect of holding the band 5 more securely can be expected thereby.

### Second Embodiment

In the second embodiment, a timepiece 200 includes the timepiece main body 1 and the exterior case 7. The shape, configuration, etc. of the timepiece main body 1 are the same as those described above, so the description thereof is omitted. The exterior case 7 that constitutes the timepiece 200 is a case that is attached to the timepiece main body 1 so as to surround the outer periphery of the timepiece main body 1, and is a second member that is selectively attached to the timepiece main body 1 in place of the bezel 3 that is the first member shown in the first embodiment.

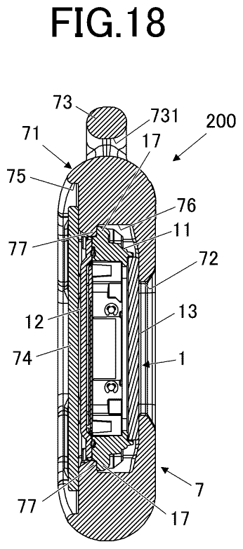

As shown in FIG. 14 etc., the exterior case 7 of the present embodiment has a case main body 71 that is approximately circular in plan view and a locking part 73 that protrudes from the case main body 71, and has a locking hole 731 formed on the outer side (the upper outer peripheral part in FIG. 14, etc.) of the case main body 71. For example, as shown in FIG. 18, the locking hole 731 is a through hole that penetrates from front to back, and a ring, carabiner, strap, rope, etc. can be hooked or passed therethrough. The exterior case 7 is formed of silicone rubber or the like that has a relatively high rubber hardness, for example. In the embodiment, the exterior case 7 is made of a transparent or semi-transparent material, and the internal configuration can be seen from the outside. The material that forms the exterior case 7 is not limited to the materials illustrated herein.

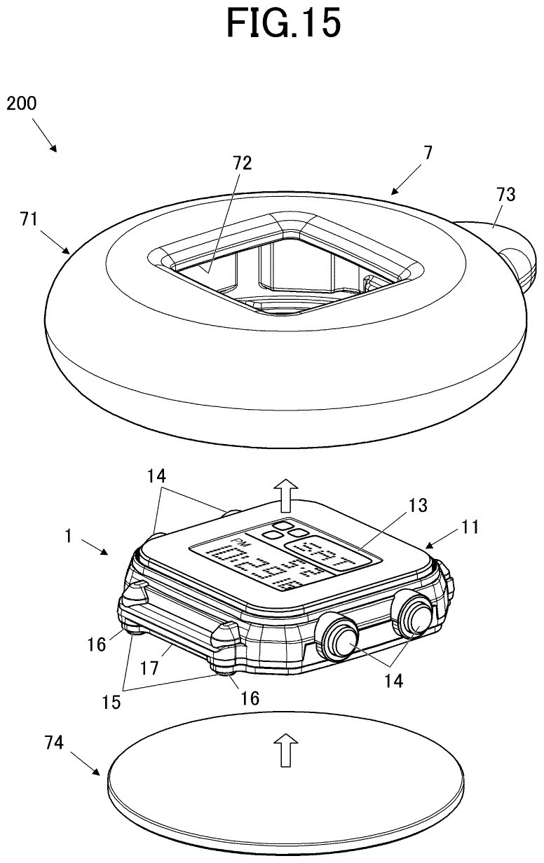

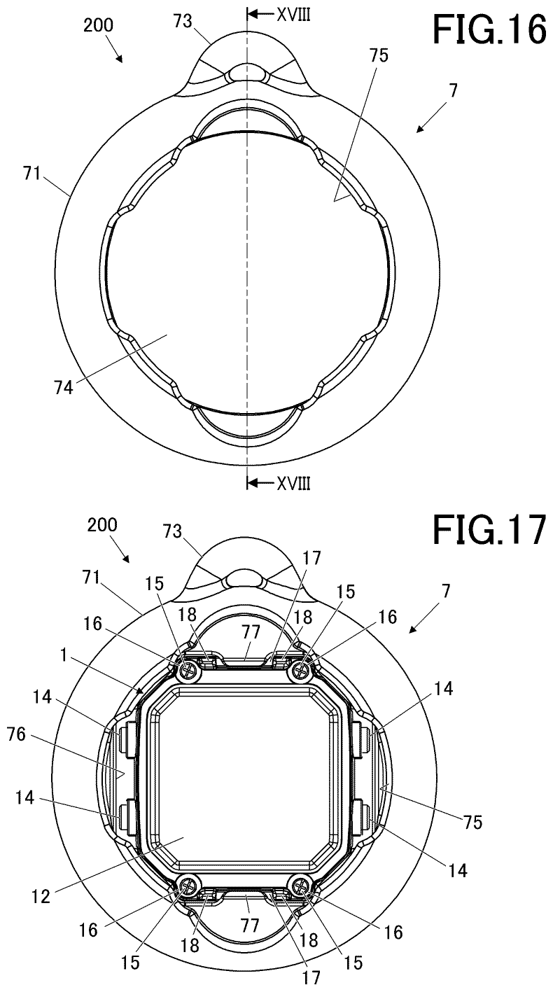

The exterior case 7 according to the embodiment is open on both the front and back. As shown in FIGS. 14 and 15, the opening 72 on the front side is formed to be approximately the same size as or slightly smaller than the size of the display panel 13 of the timepiece main body 1 so that when the exterior case 7 is attached to the timepiece main body 1, at least part of the display panel 13 of the timepiece main body 1 is exposed, making various information such as the time visible. As shown in FIGS. 16, 17, etc., the opening 75 on the back side of the exterior case 7 is formed in the size large enough to put in and out the timepiece main body 1. As shown in FIGS. 15, 16, etc., a back cover 74 is attached to the opening 75 on the back side and covers the opening part. When the back cover 74 is attached, part of the inner edge of the opening 75 is caught by the back cover 74. The part caught by the back cover 74 is formed in a hooked shape, and stops the back cover 74 not to be detached. The back cover 74 is formed of a transparent acrylic plate, for example, and the contents inside can be seen from the outside.

A housing part 76 that houses the timepiece main body 1 is provided inside the exterior case 7. As shown in FIG. 17, etc., the housing part 76 is formed in the size and shape that substantially conform to the outermost shape Es (see FIG. 2) of the timepiece main body 1. As shown in FIG. 17, for example, a corresponding inner wall of the housing part 76 is in contact with each of the sides on the 1 to 2, 4 to 5, 7 to 8, and 10 to 11 o'clock of the timepiece main body 1. As a result, the timepiece main body 1 disposed inside the housing part 76 can be positioned and prevented from shifting and looseness. As shown in FIG. 17, for example, on the 3 and 9 o'clock sides of the timepiece main body 1 where the operation units 14 are provided, sufficient space is provided to prevent the operation units 14 from coming into contact with the inner wall of the housing part 76 so that the operation units 14 are not pressed accidentally when subjected to vibrations, etc.

The exterior case 7 as the second member has second engaging parts 77 as a member-side locking part stopped by the first protruding part 17 when the exterior case 7 is attached to the timepiece main body 1. In the embodiment, as shown in FIGS. 17 and 18, the second engaging parts 77 as the member-side locking part are respectively provided at the positions corresponding to the first protruding parts 17 of the timepiece main body 1 in the housing part 76. The second engaging parts 77 are a pair of tongue-shaped members that protrude inward from the inner wall of the housing part 76, corresponding to the 6 and 12 o'clock positions of the timepiece main body 1 housed in the housing part 76. In the state where the timepiece main body 1 is housed in the housing part 76, the second engaging parts 77 are in contact with the first protruding parts 17 from the back side (the back cover 12 side of the timepiece main body 1) and engage with the first protruding parts 17. In the present embodiment, as the second engaging parts 77 and the first protruding parts 17 are engaged with each other, the exterior case 7 is locked to the timepiece main body 1.

In the first embodiment, when the bezel 3 is attached to the timepiece main body 1, the first engaging parts 37 are engaged with the first protruding parts 17 and the operation units 14 are fitted to the engagement holes 33 so that the bezel 3 is locked to the timepiece main body 1. In the present embodiment, on the other hand, when the exterior case 7 is attached to the timepiece main body 1, the exterior case 7 is locked to the timepiece main body 1 only by the engagement between the second engaging parts 77 and the first protruding parts 17. Therefore, in order to fix the exterior case 7 to the timepiece main body 1, the fixing force of the second engaging parts 77 to the timepiece main body 1 need to be larger than that of the first engaging parts 37 to the timepiece main body 1. For this reason, the second engaging part 77 is thicker than the first engaging part 37. Further, the exterior case 7 is formed of a relatively hard material such as silicone rubber, and its rigidity is higher than that of the bezel 3. Thus, the timepiece main body 1 is sufficiently fixed only by the engagement between the second engaging parts 77 and the first protruding parts 17.

In the timepiece main body 1 in the present embodiment, as described above, the adjacent ones of the screw hole spaces 16 are connected by the first protruding part 17 so that they are aligned substantially flush. Thus, the outermost shape Es of the timepiece main body 1 is in a shape comparatively straight without much unevenness, and when the exterior case 7 is formed of a transparent or semi-transparent member and the timepiece main body 1 is seen from the outside, the design can be of high quality and the appearance can be enjoyed.

The back face side of the exterior case 7 has a slight gap between the timepiece main body 1 and the back cover 74 that closes the opening 75 even in the state where the timepiece main body 1 is housed in the housing part 76. In the present embodiment, as the back cover 74 is transparent, if a photograph or the like is inserted, it can be seen from the outside through the back cover 74, and the back face side of the exterior case 7 can be customized according to the user's preferences. It is also possible that a logo or the like on the back cover 12 side of the timepiece main body 1 is to be enjoyed without a photo or the like inserted on the back face side of the exterior case 7.

Next, the effects of the timepiece 200, which is the electronic timepiece according to the second embodiment, are described. In the second embodiment, when the exterior case 7 as the second member is attached to the timepiece main body 1, as shown in FIGS. 15, 17, etc., the timepiece main body 1 is housed in the housing part 76 from the opening 75 on the back face side of the exterior case 7. At this time, the timepiece main body 1 is pressed into the housing part 76 so that the first protruding parts 17 provided on the 6 and 12 o'clock sides of the timepiece main body 1 go over the second engaging parts 77 as the member-side locking parts to be fitted to a predetermined position of the housing part 76.

As a result, once the timepiece main body is housed at the predetermined position inside the housing part 76, the pair of engaging parts 77 are in contact with the first protruding parts 17 from the back side (see FIG. 18), the second engaging parts 77 are engaged with the first protruding parts 17 and the exterior case 7 is thereby locked to the timepiece main body 1. Beside at the part where the operation units 14 are housed, the inner wall of the housing part 76 is in contact with the outer periphery of the timepiece main body 1, and the timepiece main body 1 is thereby prevented from shifting and rattling. Thereafter, the opening 75 is closed by fitting the back cover 74 to the opening 75 on the back side of the exterior case 7. In this way, the timepiece is complete (i.e. assembled). A strap, carabiner, or the like is attached to the locking part 73 in this state, the timepiece 200 can be attached to a bag or the like and carried around with the timepiece main body 1 therein.

Furthermore, when the exterior case 7 is detached from the timepiece main body 1, first, the back cover 74 is detached from the opening 75 on the back face side of the exterior case 7, and the top and bottom of the exterior case 7 where the second engaging parts 77 are provided (the upper and lower parts in FIG. 14, the part corresponding to the 6 and 12 o'clock sides of the timepiece main body housed inside) are bent toward the front side of the exterior case 7. At this time, the timepiece main body 1 can be pressed out from the front side to the back side of the exterior case. Once the second engaging parts 77 come off the first protruding parts 17 to release the engaged state as a result of this, the timepiece main body 1 can be detached from the exterior case 7. The user can attach the bezel 3 as the first member to the timepiece main body so that it can be worn on the wrist Wr, or enjoy switching to the exterior case in a different color or shape.

Next, the effects of the timepiece 200, which is the electronic timepiece according to the second embodiment and the timepiece maim body are described. In addition to the exterior case 7, the bezel 3 according to the first embodiment or the like can be attached to and detached from the timepiece 200 in the present embodiment. The bezel 3 and the exterior case 7 can be selectively attached to the timepiece main body 1. Thus, just by changing the attachment, one timepiece main body 1 can be used as a wristwatch worn on the wrist Wr, as an ornament with a strap, and in other various forms.

As described hereinbefore, the timepiece main body 1 has the screw hole spaces 16 as protrusions which protrude outward and the apexes of which constitute the outermost shape Es (see Fig. Es), and the adjacent ones of the screw hole spaces 16 are connected by the first protruding part 17 so that they are aligned substantially flush. Therefore, the outermost shape Es of the timepiece main body 1 is in a shape comparatively straight without much unevenness, and when the exterior case 7 is formed of a transparent or semi-transparent member and the timepiece main body 1 is seen from the outside, the design can be of high quality and the appearance can be enjoyed.

Furthermore, on the timepiece main body 1 in the present embodiment, the first protruding parts 17, which stop the member-side locking parts (the first engaging part 37, the second engaging part 77) when the bezel 3 as the first member or the exterior case 7 as the second member is attached to the timepiece main body 1, are formed not to protrude outward beyond the apexes of the connected screw spaces 16 on the protruding side. Therefore, the structure for attaching the bezel 3 or the exterior case 7 to the timepiece main body 1 can be realized without changing the outermost shape Es of the timepiece main body 1 (without increasing the size of the timepiece main body 1).

The exterior case 7 as the second member in the present embodiment has the housing part 76 that houses the timepiece main body 1 therein, and the second engaging parts 77 as the member-side locking part are provided at the positions corresponding to the first protruding parts 17 in the housing part 76. Therefore, in the case where the exterior case 7 is attached to the timepiece main body 1, the timepiece main body 1 is easily positioned just by being housed inside the housing part 76, and the first protruding parts 17 are locked to the second engaging parts 77 too.

Although an embodiment of the present disclosure is described above, needless to say the present disclosure is not limited to the embodiment and can be appropriately modified in a variety of aspects without departing from the scope of the present disclosure. For example, in the present embodiments, the timepiece main body 1 is substantially rectangular in plan view, but the timepiece main body 1 that constitutes the electronic timepiece 100, 200 of the present disclosure is not limited to a rectangular shaped one. For example, it may be substantially circular or substantially elliptical in plan view. In such cases, the first protruding parts are preferably formed at positions facing each other on the timepiece main body 1. This makes it possible to lock the timepiece main body 1 to the first member or the second member in a good balance at least at the position of the first protruding part, making it less likely for the timepiece main body 1 to come off.

Further, in the present embodiment, for example, the engagement holes 33 provided in the bezel 3 as the first member are through holes through which the operation units 14 as the second protruding parts are inserted, but the engagement holes are not limited to through holes. For example, they may be notched parts that can be hooked onto part of the operation units 14. In such a case, the fixing force with the through holes cannot be expected, but if the notched parts are shaped to cover the operation units 14 from the front side (the front face side of the timepiece, the upper side in FIG. 1), for example, the operation units 14 can be locked from the front side and the first protruding parts 17 are locked by the first engaging parts 37 from the back side so that the timepiece main body 1 is pressed from the front and back. The effect of preventing looseness and shifting can be thereby expected. Compared to the case where the engagement holes 33 are through holes, in the case where they are notched parts, the bezel 3 can be easily attached to and detached from the timepiece main body 1.

The timepiece main body 1 may not have the second protruding parts that protrude on the 3 and 9 o'clock sides. That is, the timepiece main body 1 may not have operation units 14 that protrude outward. In such a case, the bezel 3 does not need to have the engagement holes 33. The bezel 3 is locked to the timepiece main body 1 just by the engagement between the first protruding parts 17 and the first engaging parts 37. However, even in that case, the band 5 is positioned on the back face side of the timepiece main body 1 when the band 5 is attached to the timepiece main body 1, and the timepiece main body 1 is sandwiched between the bezel 3 and the band 5 from the front and back and is prevented from accidentally coming off.

For example, in the present embodiment, the timepiece main body 1 is housed in the housing part 76 of the exterior case 7 as the second member in the state where the 12 o'clock side faces up. However, in the case where the shapes of the four sides of the timepiece main body 1 are approximately the same as in the present embodiment, the timepiece main body 1 may be housed in a different orientation (for example, upside down or sideways) in the housing part 76. For example, when the timepiece main body 1 is used in the exterior case 7, it is housed in the housing part upside down (with the 12 o'clock side facing downwards) so that its display is lifted to the reverse orientation to be viewed like a fob watch. When the timepiece main body 1 is housed sideways, the second engaging part 77 is positioned between two of the operation units 14 on the same side. As a space equal to the space between the protective protrusions 18 for the first protruding part 17 is provided between those two operation units 14, the second engaging part 77 can be locked between the operation units 14 while avoiding the operation units 14, in the present embodiment.

In the present embodiments, although the exterior case 7 as the second member is in a substantially circular shape in plan view, for example, the shape or the like of the exterior case 7 is not limited to the illustrated example, and may be approximately elliptical or approximately rectangular in plan view. Furthermore, the exterior case 7 may be shaped like a character, an animal, or the like.

The timepiece main body 1 constituting the electronic timepiece 100, 200 according to the present disclosure includes a wide range of devices having a function of time display, and can be applied to an electronic device such as a smart watch and sports watch, a wearable device that acquires biological information such as heartbeat and blood flow in addition to giving time information.

In the above, one or more embodiments of the present invention are described. However, the scope of the present invention is not limited thereto, and includes the scope of claims below and the scope of their equivalents.

What is claimed is:

1. An electronic timepiece comprising:
a main body; and
an exterior that is attached to the main body and can hold a band,
wherein the exterior has a first opening on one end,
wherein the first opening has a first protruding part protruding inside the first opening on a side facing a back side of the band inserted through the first opening,
wherein the band has a first planar part on the back side and a second planar part that swells more than the first planar part on the back side,
wherein a boundary between the first planar part and the second planar part forms a step part,
wherein when the band is inserted through the first opening of the exterior, the step part and the first protruding part are engaged with each other, thereby holding the band to the exterior.

2. The electronic timepiece according to claim 1,
wherein the first protruding part is angled and inclined toward a direction of insertion of the band.

3. The electronic timepiece according to claim 1,
wherein the exterior is elastically deformable,
wherein when the band is inserted to the first opening, the first protruding part is inclined along a direction of insertion of the band with elastic deformation of the exterior so as to let the second planar part of the band pass through the first opening,
wherein after the second planar part passes through the first opening and when the exterior is back to an original state from the elastic deformation, the step part and the first protruding part are engaged with each other.

4. The electronic timepiece according to claim 1,
wherein when the exterior is attached to the main body, the exterior has a pair of extending parts that extend downward with respect to a back face of the main body at positions facing each other with the main body in between,
wherein the first opening is formed in one of the pair of extending parts,
wherein a second opening is formed in another one of the pair of extending part at a position facing the first opening.

5. The electronic timepiece according to claim 4,
wherein the second opening has a second protruding part that protrudes inside the second opening on a side facing the back side of the band inserted through the second opening.

6. The electronic timepiece according to claim 4,
wherein when the band inserted through the first opening is worn on a wearer, the extending part is pulled and bent toward the wearer to be elastically deformed,
wherein the first protruding part of the first opening is pressed against the step part when the extending part is bent.

7. The electronic timepiece according to claim 1,
wherein a back cover is screwed onto a back face side of the main body,
wherein a screw to fix the back cover is positioned on a path through which the band passes when the band is inserted to the first opening of the exterior, and a protective protrusion protrudes more than a head of the screw in a vicinity of the screw.

8. An exterior that is detachably attached to a main body and can hold a band, the exterior comprising:
a first extending part that extends downward with respect to a back side of the main body on one end when the exterior is attached to the main body,
wherein the first extending part includes a first opening,
wherein the first opening has a first protruding part protruding inside the first opening on a side facing a back side of the band inserted through the first opening,
wherein the band has a first planar part on the back side and a second planar part that swells more than the first planar part on the back side,
wherein a boundary between the first planar part and the second planar part forms a step part,
wherein when the band is inserted through the first opening of the exterior, the step part and the first protruding part are engaged with each other, thereby holding the band to the exterior.

9. The exterior according to claim 8, further comprising:
a second extending part that extends downward with respect to the back face of the main body at a position facing the first extending part with the main body in between when the exterior is attached to the main body,
wherein the second extending part has a second opening at a position facing the first opening.

10. The exterior according to claim 9,
wherein the second opening has a second protruding part protruding inside the second opening on a side facing the back side of the band inserted through the second opening.

11. A band that is held by an exterior attached to a main body,
wherein the band has a first planar part on a back side of the band and a second planar part that swells more than the first planar part on the back side,
wherein a boundary between the first planar part and the second planar part forms a step part,
wherein the band can be positioned on a back face side of the main body with the band being inserted to the first opening formed on one side of the exterior,
wherein the band is locked to the exterior with the step part being engaged with a first protruding part protruding inside the first opening in a state where the band is disposed on the back face side of the main body.

12. The band according to 11,
wherein the band has a sweat escape part recessed relative to a surrounding part in a cross section at a central part in a width direction of the back side of the band,
wherein the first protruding part is fitted to the sweat escape part when the band is inserted through the first opening.

13. The band according to claim 11,
wherein the band is formed of synthetic resin and has flexibility.

14. The band according to claim 11,
wherein a thickness of the band is almost uniform.

15. The band according to claim 11,
wherein the band has one or more small holes on one end side inserted to the first opening and has a pin on another end side not inserted to the first opening,
wherein the pin is locked by being inserted to one of the small holes in a state where the one end side of the band is inserted to the first opening.
